(19) United States
(12) Patent Application Publication
(10) Pub. No.: US 2023/0034565 A1
(43) Pub. Date: Feb. 2, 2023

(54) SYSTEM AND METHOD FOR OPTIMIZING CLUSTERING OUTPUTS FOR MARKETING CROSSTABS

(71) Applicant: ROSEMARK CAPITAL MANAGEMENT COMPANY LP, Princeton, NJ (US)

(72) Inventors: Chris Kuenne, Princeton, NJ (US); Lawrence Choi, Philadelphia, PA (US)

(21) Appl. No.: 17/388,492

(22) Filed: Jul. 29, 2021

(51) Int. Cl. G06Q 30/02; G06F 16/28

(52) U.S. Cl. CPC G06Q 30/0203; G06Q 30/0206; G06Q 30/0201; G06F 16/287; G06F 40/30

(57) ABSTRACT

Various aspects of the subject technology relate to systems, methods, and machine-readable media for optimizing clustering outputs. The method includes receiving data collected from a plurality of respondents. The method also includes grouping the plurality of respondents to a plurality of response groups based on a plurality of factors. The method also includes calculating, for each question of the plurality of questions, a fractional breakdown of each response group based at least in part on each response to each question. The method also includes calculating, for each response group of the plurality of response groups, a plurality of fractional groupings based at least in part on a grouping map. The method also includes selecting, for each response group of the plurality of response groups, a fractional grouping from the plurality of fractional groupings that satisfies a predefined criteria. The method also includes outputting the selected fractional groupings.

### TECHNICAL FIELD

The present disclosure generally relates to surveys, and more particularly to clustering survey results for generating crosstabs.

### BACKGROUND

Surveys are a common way of conducting market research. Market research surveys typically collect data using survey instruments in which respondents are asked multiple questions. The results of the survey may be utilized to improve products and/or services for consumers.

### BRIEF SUMMARY

The subject disclosure provides for systems and methods for clustering survey results for generating crosstabs. In an aspect, a computer-implemented method for optimizing clustering outputs includes receiving data collected from a plurality of respondents through a survey comprising a plurality of questions, the data comprising a plurality of responses to the plurality of questions by the plurality of respondents. The method also includes grouping the plurality of respondents to a plurality of response groups based on a plurality of factors. The method also includes calculating, for each question of the plurality of questions, a fractional breakdown of each response group based at least in part on each response to each question. The method also includes calculating, for each response group of the plurality of response groups, a plurality of fractional groupings based at least in part on a grouping map. The method also includes selecting, for each response group of the plurality of response groups, a fractional grouping from the plurality of fractional groupings that satisfies a predefined criteria. The method also includes causing display of the selected fractional groupings as an output.

According to one embodiment of the present disclosure, a system is provided including a processor and a memory comprising instructions stored thereon, which when executed by the processor, causes the processor to perform a method for optimizing clustering outputs. The method includes receiving data collected from a plurality of respondents through a survey comprising a plurality of questions, the data comprising a plurality of responses to the plurality of questions by the plurality of respondents. The method also includes grouping the plurality of respondents to a plurality of response groups based on a plurality of factors. The method also includes calculating, for each question of the plurality of questions, a fractional breakdown of each response group based at least in part on each response to each question. The method also includes calculating, for each response group of the plurality of response groups, a plurality of fractional groupings based at least in part on a grouping map. The method also includes selecting, for each response group of the plurality of response groups, a fractional grouping from the plurality of fractional groupings that satisfies a predefined criteria. The method also includes causing display of the selected fractional groupings as an output.

According to one embodiment of the present disclosure, a non-transitory computer-readable storage medium is provided including instructions (e.g., stored sequences of instructions) that, when executed by a processor, cause the processor to perform a method for optimizing clustering outputs. The method includes receiving data collected from a plurality of respondents through a survey comprising a plurality of questions, the data comprising a plurality of responses to the plurality of questions by the plurality of respondents. The method also includes grouping the plurality of respondents to a plurality of response groups based on a plurality of factors. The method also includes calculating, for each question of the plurality of questions, a fractional breakdown of each response group based at least in part on each response to each question. The method also includes calculating, for each response group of the plurality of response groups, a plurality of fractional groupings based at least in part on a grouping map. The method also includes selecting, for each response group of the plurality of response groups, a fractional grouping from the plurality of fractional groupings that satisfies a predefined criteria. The method also includes causing display of the selected fractional groupings as an output.

According to one embodiment of the present disclosure, a system is provided that includes means for storing instructions, and means for executing the stored instructions that, when executed by the means, cause the means to perform a method for optimizing clustering outputs. The method includes receiving data collected from a plurality of respondents through a survey comprising a plurality of questions, the data comprising a plurality of responses to the plurality of questions by the plurality of respondents. The method also includes grouping the plurality of respondents to a plurality of response groups based on a plurality of factors. The method also includes calculating, for each question of the plurality of questions, a fractional breakdown of each response group based at least in part on each response to each question. The method also includes calculating, for each response group of the plurality of response groups, a plurality of fractional groupings based at least in part on a grouping map. The method also includes selecting, for each response group of the plurality of response groups, a fractional grouping from the plurality of fractional groupings that satisfies a predefined criteria. The method also includes causing display of the selected fractional groupings as an output.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates exemplary data gathered from a survey, according to certain aspects of the present disclosure.

FIG. 2 illustrates exemplary fractional groupings based on a grouping map, according to certain aspects of the present disclosure.

FIG. 3 illustrates exemplary remapped groupings based on selected fractional groupings, according to certain aspects of the present disclosure.

FIG. 4 illustrates a system configured for optimizing clustering outputs, in accordance with one or more implementations

FIG. 5 illustrates an example flow diagram for optimizing clustering outputs, according to certain aspects of the present disclosure.

FIG. 6 is a block diagram illustrating an example computer system (e.g., representing both client and server) with which aspects of the subject technology can be implemented.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

In the following detailed description, numerous specific details are set forth to provide a full understanding of the present disclosure. It will be apparent, however, to one ordinarily skilled in the art that the embodiments of the present disclosure may be practiced without some of these specific details. In other instances, well-known structures and techniques have not been shown in detail so as not to obscure the disclosure.

Surveys are a common way of conducting market research. Market research surveys typically collect data using survey instruments in which respondents are asked multiple questions. The results of the survey may be utilized to improve products and/or services for consumers. However, there is a need for improved clustering of the data that is gathered in order to draw accurate interpretations.

One of the challenges in segmentation (i.e., the clustering of data to form unique consumer segments), such as through using 7-point Likert scale data, is that while the 7 points capture consumer response with precision, there are too many degrees of freedom when clustering occurs. Conventional clustering solutions solve for this issue by requiring that the 7-points be discretized into 3 categories. For example, the 7 points collapse into “disagree”, “neutral”, and “agree”. There are procedures for automating this discretization for use in clustering. However, generating crosstabs using this automatically discretized data often results in outputs that are difficult to interpret by marketers. This is because the automated discretization process does not understand what the individual point values in the Likert scale mean—all it does is attempt to group the responses into a Gaussian (or other) heuristic. As a result, it is difficult for marketers to interpret the segments.

Accordingly, there is a need for improved clustering of data that overcomes these shortcomings. Aspects of the present disclosure address these issues by providing for systems and methods for optimizing clustering outputs. In an aspect, a fractional response is calculated for each individual Likert scale point. Fractional groupings are then calculated based on multiple scenarios. A response distribution scenario is selected that best approximates a standard distribution. Values in the dataset are then replaced with the mapped groupings that were selected. A cross-tab may then be generated.

The disclosed system addresses a problem in traditional clustering of data tied to computer technology, namely, the technical problem of optimizing clustering outputs. The disclosed system solves this technical problem by providing a solution also rooted in computer technology, namely, by providing for optimized clustering outputs. The disclosed system also improves the functioning of the computer itself because it trains the computer to recognize and extract relevant information from survey responses.

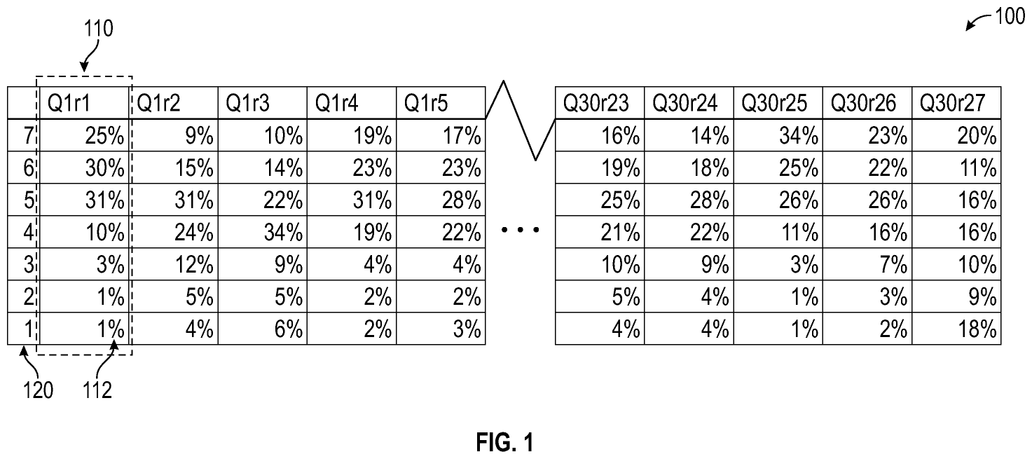

FIG. 1 illustrates exemplary data 100 gathered from a survey, according to certain aspects of the present disclosure. For example, the survey may include survey instruments with a plurality of questions that were asked to each respondent. The data 100 may include a plurality of responses to the plurality of questions by the plurality of respondents. For example, the responses may be based on a Likert scale 120 of 1 (i.e., disagree) to 7 (i.e., agree), where 4 is neutral.

According to aspects, the respondents may be grouped into a plurality of response groups based on a plurality of factors. For example, the plurality of factors may include at least one of age, ethnicity, gender, income, and/or location, etc. In an implementation, each response group may correlate to a certain question. For example, a first response group 110 may be correlated with a first question of the survey. As illustrated in FIG. 1, the first response group 110 may be labeled as “Q1r1”, where “Q1” refers to a first question, and “r1” refers to a first group of responses to the first question. Similarly, every subsequent response group may be similarly labeled as “Qxry”, where x and y are integers. The response groups may also include entities or groups of entities.

According to aspects, a fractional breakdown of each response group, for each question of the plurality of questions, may be calculated based at least in part on each response to each question. The survey may be based on a Likert scale 120. For example, the first response group 110 may have a first fractional breakdown 112 of respondents as follows: 25% strongly agree (i.e., 7), 30% agree (i.e., 6), 31% slightly agree (i.e., 5), 10% are neutral (i.e., 4), 3% slightly disagree (i.e., 3), 1% disagree (i.e., 2), and 1% strongly disagree (i.e., 1).

According to aspects, for a question response to be treated as relevant to a segment, the response fraction of “Agree”, “Neutral”, or “Disagree” should meet the following criteria: 1) Fraction greater than or equal to 40%, and 2) Index greater than or equal to 120. The index is a relative measure of whether the fraction in the segment is relatively greater than the fraction in the total population. For example, if Segment 1 has 40% agreement with question 1 whereas the aggregate has 20% agreement with question 1, Segment 1's index for question 1 would be 200 (e.g., 40%/20%×100). If these criteria were not met, then it would be very difficult to make accurate interpretations. Conventional techniques for automated discretization typically fail these criteria. However, when response distributions are pivoted using neutral, the results are easier to interpret, as will be described below.

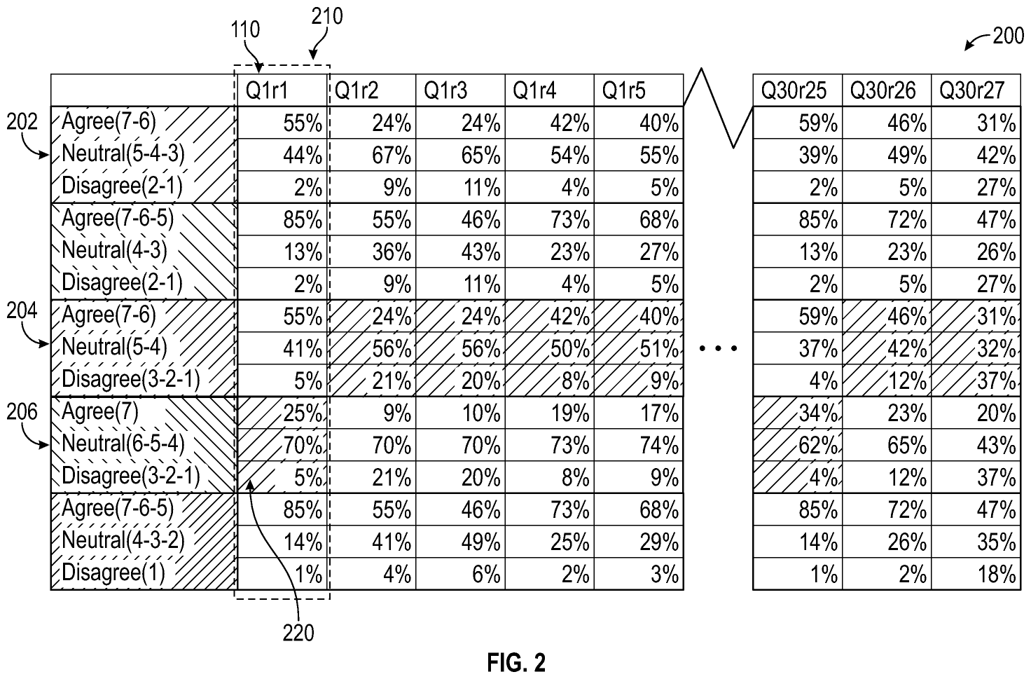

FIG. 2 illustrates exemplary fractional groupings based on a grouping map 200, according to certain aspects of the present disclosure. For example, the grouping map 200 may include a plurality of mappings for each response of the plurality of responses (e.g., multiple scenarios). Each scenario may cluster the responses differently. For example, a first scenario may map Likert scale points as follows: 7 and 6 map to “Agree”; 3, 4, and 5 map to “Neutral”; and 1 and 2 map to “Disagree”. As illustrated in FIG. 2, each subsequent scenario may include a slightly different mapping for the Likert scale points, where 4 is always “Neutral”. That is, 4 serves as a pivot point in the analysis. Use of a scale with an odd number of response options, e.g., a 5-point, 7-point, or 9-point Likert scale tends to yield better results as there is an intuitive pivot point at the middle of such scales. It is understood that although five scenarios are illustrated, more or less scenarios may be included without departing from the scope of the disclosure.

According to aspects, for each response group of the plurality of response groups, a plurality of fractional groupings may be calculated based at least in part on the grouping map 200. For example, first fractional groupings 210 may be calculated for the first response group 110. As a result, a first scenario 202 of the first fractional groupings 210 may be mapped as follows: 55% agree, 44% are neutral, and 2% disagree. Similarly, as illustrated in FIG. 2, the other fractional groupings 210 of the first response group 110 may be calculated based on the other scenarios in the grouping map 200.

According to aspects, once the fractional groupings 210 are calculated, for each response group of the plurality of response groups, a single fractional grouping 220 may be selected that satisfies a predefined criteria. For example, the predefined criteria may be the closest match among the fractional groupings 210 to a 25%/50%/25% distribution.

According to aspects, the closest match to the desired 25%/50%/25% distribution (e.g., the desired distribution) may be determined by treating each grouping 210 as a vector. For example, the groupings 210 and the desired distribution may be represented as vectors having coordinates in a 3-D Cartesian plane. In an implementation, the coordinates may be in the form of (X, Y, Z), where X corresponds to “Agree”, Y corresponds to “Neutral”, and Z corresponds to “Disagree.” For example, the coordinates for the fractional grouping 210 for the first scenario 202 may be (55, 44, 2). Additionally, the coordinates for the desired distribution may be (25, 50, 25). All of the coordinates to the vectors may be compared to each other and also to the coordinates of the desired distribution. The vectors that are within a minimum Euclidean distance from the desired 25%/50%/25% distribution may be selected. As illustrated in FIG. 2, the coordinates for the fractional grouping 220 for the fourth scenario 206 may be (25, 70, 5), which is closest to (25, 50, 25) of all the other groupings 210. Therefore, grouping 220 has been selected from the first response group 110.

In addition or the alternative, the predefined criteria may include one or more minimum and/or maximum percentage values for each category. For example, the categories “agree” and “disagree” must be above a value selected from a range of between 5% and 10% and the category of “neutral” can be no greater than a value selected from a range of between 70% to 80%. The predefined criteria may also include non-mathematical and/or semantic criteria. For example, the selection must reflect a semantic meaning of at least survey response, such as a response value of 4 having a semantic value of neutral, regardless of the mathematical distribution of response. Additionally, the selecting of the selected fractional grouping 220 may be based at least in part on matching the response distribution to a Gaussian distribution (or other heuristic).

According to aspects, the grouping of the fractional groupings 210 does not impact the clustering of respondents. For example, the fractional grouping selections may be made after clusters are already generated. In an implementation, the principles used to create the clusters is different than the principles used to do the fractional grouping selections. For example, clustering may be done according to Gaussian distributions or traditional mathematical clustering principles, while the fractional grouping selection may be based on other criteria, such as semantic criteria.

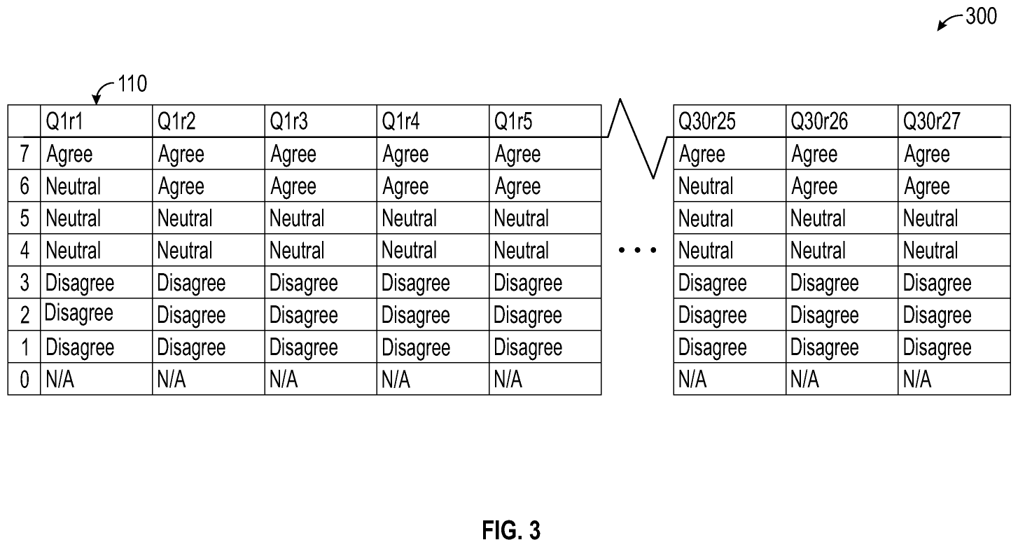

FIG. 3 illustrates exemplary remapped groupings 300 based on selected fractional groupings, according to certain aspects of the present disclosure. For example, referring to FIG. 2, the first response group 110 (e.g., QM) may have a selected fractional grouping 220 that correlates to a fourth scenario 206. Additionally, each of response groups Q1r2, Q1r3, Q1r4, and Q1r5 may have selected fractional groupings that correlate to a third scenario 204.

According to aspects, the responses may be replaced based on the remapped groupings 300. For example, the responses of the first response group 110 may be replaced according to the mapping 200 that corresponds to the selected fractional grouping 220. As illustrated in FIG. 3, for the first response group 110, a response of 7 is “Agree”, a response of 4, 5, or 6 is “Neutral”, and a response of 1, 2, or 3 is “Disagree”. Once each of the responses are similarly replaced for each of the response groups, the remapped groupings 300 may be output as a cross-tab.

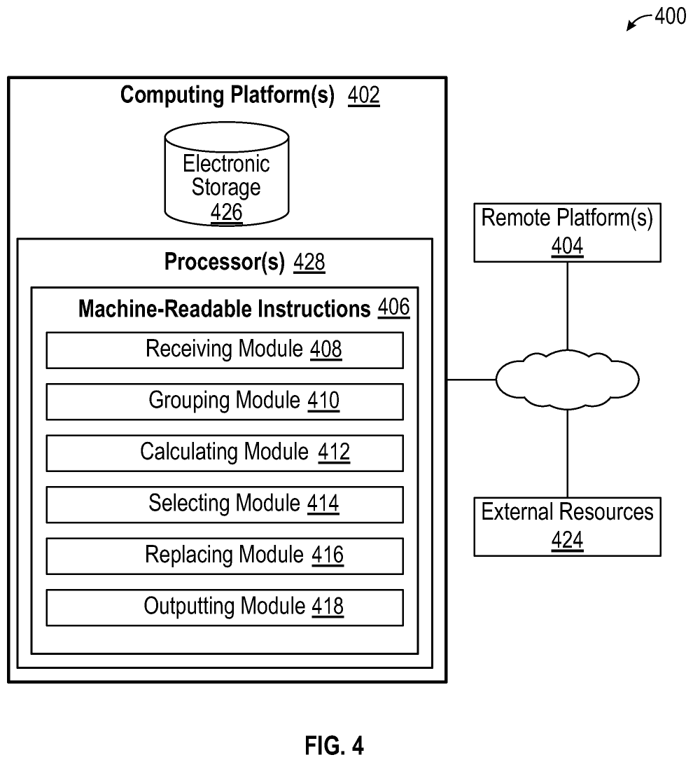

FIG. 4 illustrates a system 400 configured for optimizing clustering outputs, in accordance with one or more implementations. In some implementations, system 400 may include one or more computing platforms 402. Computing platform(s) 402 may be configured to communicate with one or more remote platforms 404 according to a client/server architecture, a peer-to-peer architecture, and/or other architectures. Remote platform(s) 404 may be configured to communicate with other remote platforms via computing platform(s) 402 and/or according to a client/server architecture, a peer-to-peer architecture, and/or other architectures. Users may access system 400 via remote platform(s) 404.

Computing platform(s) 402 may be configured by machine-readable instructions 406. Machine-readable instructions 406 may include one or more instruction modules. The instruction modules may include computer program modules. The instruction modules may include one or more of receiving module 408, grouping module 410, calculating determining module 412, selecting module 414, replacing module 416, outputting module 418 and/or other instruction modules.

Receiving module 408 may be configured to receive data collected from a plurality of respondents through a survey comprising a plurality of questions.

Grouping module 410 may be configured to group the plurality of respondents to a plurality of response groups based on a plurality of factors.

Calculating determining module 412 may be configured to calculate, for each question of the plurality of questions, a fractional breakdown of each response group based at least in part on each response to each question. Calculating determining module 412 may also be configured to calculate, for each response group of the plurality of response groups, a plurality of fractional groupings based at least in part on a grouping map.

Selecting module 414 may be configured to select, for each response group of the plurality of response groups, a fractional grouping from the plurality of fractional groupings that satisfies a predefined criteria.

Replacing module 416 may be configured to replace, for each response of the plurality of responses, values of the data with the fractional grouping that was selected.

Outputting module 418 may be configured to cause display of the selected fractional groupings as an output.

In some implementations, computing platform(s) 402, remote platform(s) 404, and/or external resources 424 may be operatively linked via one or more electronic communication links. For example, such electronic communication links may be established, at least in part, via a network such as the Internet and/or other networks. It will be appreciated that this is not intended to be limiting, and that the scope of this disclosure includes implementations in which computing platform(s) 402, remote platform(s) 404, and/or external resources 424 may be operatively linked via some other communication media.

A given remote platform 404 may include one or more processors configured to execute computer program modules. The computer program modules may be configured to enable an expert or user associated with the given remote platform 404 to interface with system 400 and/or external resources 424, and/or provide other functionality attributed herein to remote platform(s) 404. By way of non-limiting example, a given remote platform 404 and/or a given computing platform 402 may include one or more of a server, a desktop computer, a laptop computer, a handheld computer, a tablet computing platform, a NetBook, a Smartphone, a gaming console, and/or other computing platforms.

External resources 424 may include sources of information outside of system 400, external entities participating with system 400, and/or other resources. In some implementations, some or all of the functionality attributed herein to external resources 424 may be provided by resources included in system 400.

Computing platform(s) 402 may include electronic storage 426, one or more processors 428, and/or other components. Computing platform(s) 402 may include communication lines, or ports to enable the exchange of information with a network and/or other computing platforms. Illustration of computing platform(s) 402 in FIG. 4 is not intended to be limiting. Computing platform(s) 402 may include a plurality of hardware, software, and/or firmware components operating together to provide the functionality attributed herein to computing platform(s) 402. For example, computing platform(s) 402 may be implemented by a cloud of computing platforms operating together as computing platform(s) 402.

Electronic storage 426 may comprise non-transitory storage media that electronically stores information. The electronic storage media of electronic storage 426 may include one or both of system storage that is provided integrally (i.e., substantially non-removable) with computing platform(s) 402 and/or removable storage that is removably connectable to computing platform(s) 402 via, for example, a port (e.g., a USB port, a firewire port, etc.) or a drive (e.g., a disk drive, etc.). Electronic storage 426 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. Electronic storage 426 may include one or more virtual storage resources (e.g., cloud storage, a virtual private network, and/or other virtual storage resources). Electronic storage 426 may store software algorithms, information determined by processor(s) 428, information received from computing platform(s) 402, information received from remote platform(s) 404, and/or other information that enables computing platform(s) 402 to function as described herein.

Processor(s) 428 may be configured to provide information processing capabilities in computing platform(s) 402. As such, processor(s) 428 may include one or more of a digital processor, an analog processor, a digital circuit designed to process information, an analog circuit designed to process information, a state machine, and/or other mechanisms for electronically processing information. Although processor(s) 428 is shown in FIG. 4 as a single entity, this is for illustrative purposes only. In some implementations, processor(s) 428 may include a plurality of processing units. These processing units may be physically located within the same device, or processor(s) 428 may represent processing functionality of a plurality of devices operating in coordination. Processor(s) 428 may be configured to execute modules 408, 410, 412, 414, 416, and/or 418, and/or other modules. Processor(s) 428 may be configured to execute modules 408, 410, 412, 414, 416, and/or 418, and/or other modules by software; hardware; firmware; some combination of software, hardware, and/or firmware; and/or other mechanisms for configuring processing capabilities on processor(s) 428. As used herein, the term “module” may refer to any component or set of components that perform the functionality attributed to the module. This may include one or more physical processors during execution of processor readable instructions, the processor readable instructions, circuitry, hardware, storage media, or any other components.

It should be appreciated that although modules 408, 410, 412, 414, 416, and/or 418 are illustrated in FIG. 4 as being implemented within a single processing unit, in implementations in which processor(s) 428 includes multiple processing units, one or more of modules 408, 410, 412, 414, 416, and/or 418 may be implemented remotely from the other modules. The description of the functionality provided by the different modules 408, 410, 412, 414, 416, and/or 418 described below is for illustrative purposes, and is not intended to be limiting, as any of modules 408, 410, 412, 414, 416, and/or 418 may provide more or less functionality than is described. For example, one or more of modules 408, 410, 412, 414, 416, and/or 418 may be eliminated, and some or all of its functionality may be provided by other ones of modules 408, 410, 412, 414, 416, and/or 418. As another example, processor(s) 428 may be configured to execute one or more additional modules that may perform some or all of the functionality attributed below to one of modules 408, 410, 412, 414, 416, and/or 418.

The techniques described herein may be implemented as method(s) that are performed by physical computing device(s); as one or more non-transitory computer-readable storage media storing instructions which, when executed by computing device(s), cause performance of the method(s); or, as physical computing device(s) that are specially configured with a combination of hardware and software that causes performance of the method(s).

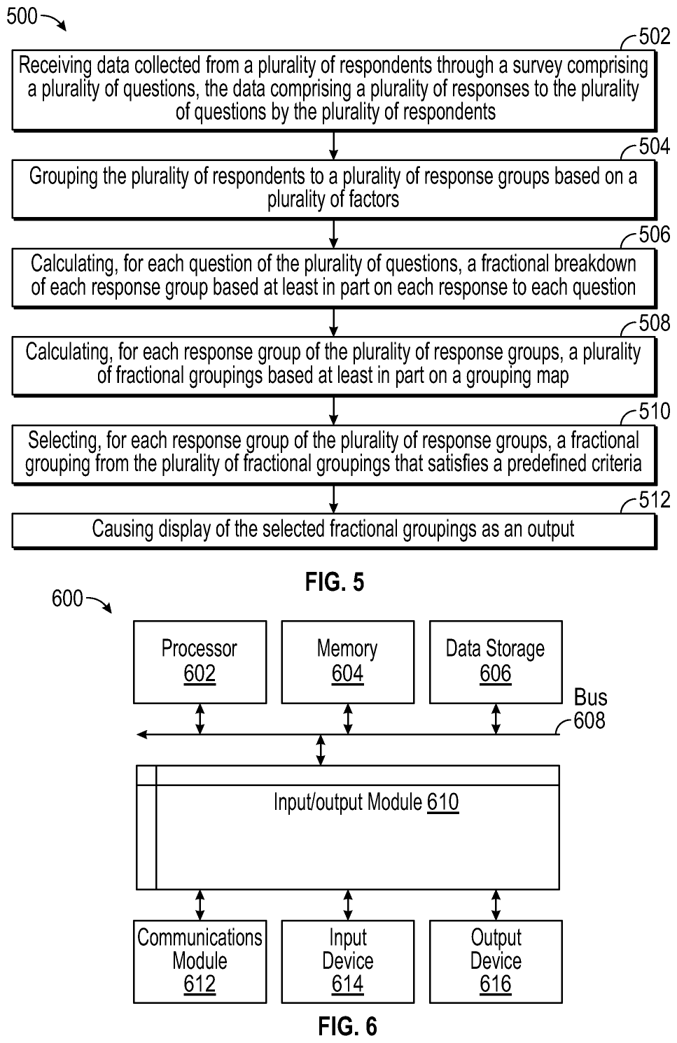

FIG. 5 illustrates an example flow diagram (e.g., process 500) for optimizing clustering outputs, according to certain aspects of the disclosure. For explanatory purposes, the example process 400 is described herein with reference to FIGS. 1-4. Further for explanatory purposes, the steps of the example process 500 are described herein as occurring in serial, or linearly. However, multiple instances of the example process 500 may occur in parallel. For purposes of explanation of the subject technology, the process 500 will be discussed in reference to FIGS. 1-4.

At step 502, data collected from a plurality of respondents through a survey comprising a plurality of questions is received. The data may include a plurality of responses to the plurality of questions by the plurality of respondents.

At step 504, the plurality of respondents are grouped to a plurality of response groups based on a plurality of factors.

At step 506, for each question of the plurality of questions, a fractional breakdown of each response group is calculated based at least in part on each response to each question.

At step 508, for each response group of the plurality of response groups, a plurality of fractional groupings is calculated based at least in part on a grouping map.

At step 510, for each response group of the plurality of response groups, a fractional grouping from the plurality of fractional groupings is selected that satisfies a predefined criteria.

At step 512, the selected fractional groupings are caused to be displayed as an output.

For example, as described above in relation to FIGS. 1-4, at step 502, data (e.g., data 100) collected from a plurality of respondents through a survey comprising a plurality of questions is received (e.g., through receiving module 408). The data may include a plurality of responses to the plurality of questions by the plurality of respondents. At step 504, the plurality of respondents are grouped (e.g., through grouping module 410) to a plurality of response groups (e.g., first response group 110) based on a plurality of factors. At step 506, for each question of the plurality of questions, a fractional breakdown (e.g., first fractional breakdown 112) of each response group is calculated (e.g., through calculating module 412) based at least in part on each response to each question. At step 508, for each response group of the plurality of response groups, a plurality of fractional groupings (e.g., first fractional groupings 210) is calculated (e.g., through calculating module 412) based at least in part on a grouping map (e.g., grouping map 200). At step 510, for each response group of the plurality of response groups, a fractional grouping (e.g., selected fractional grouping 220) from the plurality of fractional groupings is selected (e.g., through selecting module 414) that satisfies a predefined criteria. At step 512, the selected fractional groupings (e.g., the remapping 300) are caused to be displayed as an output (e.g., through outputting module 418).

According to an aspect, the process 500 may further include replacing, for each response of the plurality of responses, values of the data with the fractional grouping that was selected.

According to an aspect, the plurality of fractional groupings are represented as vectors having coordinates in a Cartesian plane, wherein vectors that are within a minimum Euclidean distance from the desired distribution are selected. According to an aspect, the response groups comprise entities or groups of entities.

According to an aspect, the grouping map comprises a plurality of mappings for each response of the plurality of responses. According to an aspect, the output includes at least a cross-tab.

According to an aspect, the plurality of factors includes at least one of age, ethnicity, gender, income, and/or location. According to an aspect, the selecting of the fractional grouping is based at least in part on a comparison of the fractional groupings to a Gaussian distribution.

According to an aspect, the predefined criteria comprises a closest match to a 25%/50%/25% distribution. According to an aspect, the predefined criteria comprise at least one of non-mathematical and/or semantic criteria.

FIG. 6 is a block diagram illustrating an exemplary computer system 600 with which aspects of the subject technology can be implemented. In certain aspects, the computer system 600 may be implemented using hardware or a combination of software and hardware, either in a dedicated server, integrated into another entity, or distributed across multiple entities.

Computer system 600 (e.g., server and/or client) includes a bus 608 or other communication mechanism for communicating information, and a processor 602 coupled with bus 608 for processing information. By way of example, the computer system 600 may be implemented with one or more processors 602. Processor 602 may be a general-purpose microprocessor, a microcontroller, a Digital Signal Processor (DSP), an Application Specific Integrated Circuit (ASIC), a Field Programmable Gate Array (FPGA), a Programmable Logic Device (PLD), a controller, a state machine, gated logic, discrete hardware components, or any other suitable entity that can perform calculations or other manipulations of information.

Computer system 600 can include, in addition to hardware, code that creates an execution environment for the computer program in question, e.g., code that constitutes processor firmware, a protocol stack, a database management system, an operating system, or a combination of one or more of them stored in an included memory 604, such as a Random Access Memory (RAM), a flash memory, a Read Only Memory (ROM), a Programmable Read-Only Memory (PROM), an Erasable PROM (EPROM), registers, a hard disk, a removable disk, a CD-ROM, a DVD, or any other suitable storage device, coupled to bus 608 for storing information and instructions to be executed by processor 602. The processor 602 and the memory 604 can be supplemented by, or incorporated in, special purpose logic circuitry.

The instructions may be stored in the memory 604 and implemented in one or more computer program products, i.e., one or more modules of computer program instructions encoded on a computer readable medium for execution by, or to control the operation of, the computer system 600, and according to any method well-known to those of skill in the art, including, but not limited to, computer languages such as data-oriented languages (e.g., SQL, dBase), system languages (e.g., C, Objective-C, C++, Assembly), architectural languages (e.g., Java, .NET), and application languages (e.g., PHP, Ruby, Perl, Python). Instructions may also be implemented in computer languages such as array languages, aspect-oriented languages, assembly languages, authoring languages, command line interface languages, compiled languages, concurrent languages, curly-bracket languages, dataflow languages, data-structured languages, declarative languages, esoteric languages, extension languages, fourth-generation languages, functional languages, interactive mode languages, interpreted languages, iterative languages, list-based languages, little languages, logic-based languages, machine languages, macro languages, metaprogramming languages, multiparadigm languages, numerical analysis, non-English-based languages, object-oriented class-based languages, object-oriented prototype-based languages, off-side rule languages, procedural languages, reflective languages, rule-based languages, scripting languages, stack-based languages, synchronous languages, syntax handling languages, visual languages, wirth languages, and xml-based languages. Memory 604 may also be used for storing temporary variable or other intermediate information during execution of instructions to be executed by processor 602.

A computer program as discussed herein does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program can be deployed to be executed on one computer or on multiple computers that are located at one site or distributed across multiple sites and interconnected by a communication network. The processes and logic flows described in this specification can be performed by one or more programmable processors executing one or more computer programs to perform functions by operating on input data and generating output.

Computer system 600 further includes a data storage device 606 such as a magnetic disk or optical disk, coupled to bus 608 for storing information and instructions. Computer system 600 may be coupled via input/output module 610 to various devices. The input/output module 610 can be any input/output module. Exemplary input/output modules 610 include data ports such as USB ports. The input/output module 610 is configured to connect to a communications module 612. Exemplary communications modules 612 include networking interface cards, such as Ethernet cards and modems. In certain aspects, the input/output module 610 is configured to connect to a plurality of devices, such as an input device 614 and/or an output device 616. Exemplary input devices 614 include a keyboard and a pointing device, e.g., a mouse or a trackball, by which a user can provide input to the computer system 600. Other kinds of input devices 614 can be used to provide for interaction with a user as well, such as a tactile input device, visual input device, audio input device, or brain-computer interface device. For example, feedback provided to the user can be any form of sensory feedback, e.g., visual feedback, auditory feedback, or tactile feedback, and input from the user can be received in any form, including acoustic, speech, tactile, or brain wave input. Exemplary output devices 616 include display devices such as an LCD (liquid crystal display) monitor for displaying information to the user.

According to one aspect of the present disclosure, the above-described gaming systems can be implemented using a computer system 600 in response to processor 602 executing one or more sequences of one or more instructions contained in memory 604. Such instructions may be read into memory 604 from another machine-readable medium, such as data storage device 606. Execution of the sequences of instructions contained in the main memory 604 causes processor 602 to perform the process steps described herein. One or more processors in a multi-processing arrangement may also be employed to execute the sequences of instructions contained in memory 604. In alternative aspects, hard-wired circuitry may be used in place of or in combination with software instructions to implement various aspects of the present disclosure. Thus, aspects of the present disclosure are not limited to any specific combination of hardware circuitry and software.

Various aspects of the subject matter described in this specification can be implemented in a computing system that includes a back end component, e.g., such as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. The communication network can include, for example, any one or more of a LAN, a WAN, the Internet, and the like. Further, the communication network can include, but is not limited to, for example, any one or more of the following network topologies, including a bus network, a star network, a ring network, a mesh network, a star-bus network, tree or hierarchical network, or the like. The communications modules can be, for example, modems or Ethernet cards.

Computer system 600 can include clients and servers. A client and server are generally remote from each other and typically interact through a communication network. The relationship of client and server arises by virtue of computer programs running on the respective computers and having a client-server relationship to each other. Computer system 600 can be, for example, and without limitation, a desktop computer, laptop computer, or tablet computer. Computer system 600 can also be embedded in another device, for example, and without limitation, a mobile telephone, a PDA, a mobile audio player, a Global Positioning System (GPS) receiver, a video game console, and/or a television set top box.

The term “machine-readable storage medium” or “computer readable medium” as used herein refers to any medium or media that participates in providing instructions to processor 602 for execution. Such a medium may take many forms, including, but not limited to, non-volatile media, volatile media, and transmission media. Non-volatile media include, for example, optical or magnetic disks, such as data storage device 606. Volatile media include dynamic memory, such as memory 604. Transmission media include coaxial cables, copper wire, and fiber optics, including the wires that comprise bus 608. Common forms of machine-readable media include, for example, floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH EPROM, any other memory chip or cartridge, or any other medium from which a computer can read. The machine-readable storage medium can be a machine-readable storage device, a machine-readable storage substrate, a memory device, a composition of matter effecting a machine-readable propagated signal, or a combination of one or more of them.

As the user computing system 600 reads game data and provides a game, information may be read from the game data and stored in a memory device, such as the memory 604. Additionally, data from the memory 604 servers accessed via a network the bus 608, or the data storage 606 may be read and loaded into the memory 604. Although data is described as being found in the memory 604, it will be understood that data does not have to be stored in the memory 604 and may be stored in other memory accessible to the processor 602 or distributed among several media, such as the data storage 606.

As used herein, the phrase “at least one of” preceding a series of items, with the terms “and” or “or” to separate any of the items, modifies the list as a whole, rather than each member of the list (i.e., each item). The phrase “at least one of” does not require selection of at least one item; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

To the extent that the terms “include”, “have”, or the like is used in the description or the claims, such term is intended to be inclusive in a manner similar to the term “comprise” as “comprise” is interpreted when employed as a transitional word in a claim. The word “exemplary” is used herein to mean “serving as an example, instance, or illustration”. Any embodiment described herein as “exemplary” is not necessarily to be construed as preferred or advantageous over other embodiments.

A reference to an element in the singular is not intended to mean “one and only one” unless specifically stated, but rather “one or more”. All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description.

While this specification contains many specifics, these should not be construed as limitations on the scope of what may be claimed, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

The subject matter of this specification has been described in terms of particular aspects, but other aspects can be implemented and are within the scope of the following claims. For example, while operations are depicted in the drawings in a particular order, this should not be understood as requiring that such operations be performed in the particular order shown or in sequential order, or that all illustrated operations be performed to achieve desirable results. The actions recited in the claims can be performed in a different order and still achieve desirable results. As one example, the processes depicted in the accompanying figures do not necessarily require the particular order shown, or sequential order, to achieve desirable results. In certain circumstances, multitasking and parallel processing may be advantageous. Moreover, the separation of various system components in the aspects described above should not be understood as requiring such separation in all aspects, and it should be understood that the described program components and systems can generally be integrated together in a single software product or packaged into multiple software products. Other variations are within the scope of the following claims.

What is claimed is:

1. A computer-implemented method for optimizing clustering outputs, comprising:
receiving data collected from a plurality of respondents through a survey comprising a plurality of questions, the data comprising a plurality of responses to the plurality of questions by the plurality of respondents;
grouping the plurality of respondents to a plurality of response groups based on a plurality of factors;
calculating, for each question of the plurality of questions, a fractional breakdown of each response group based at least in part on each response to each question;
calculating, for each response group of the plurality of response groups, a plurality of fractional groupings based at least in part on a grouping map;
selecting, for each response group of the plurality of response groups, a fractional grouping from the plurality of fractional groupings that satisfies a predefined criteria; and
causing display of the selected fractional groupings as an output.

2. The computer-implemented method of claim 1, further comprising:
replacing, for each response of the plurality of responses, values of the data with the fractional grouping that was selected.

3. The computer-implemented method of claim 1, wherein the plurality of fractional groupings and a desired distribution are represented as vectors having coordinates in a Cartesian plane, wherein vectors that are within a minimum Euclidean distance from the desired distribution are selected.

4. The computer-implemented method of claim 1, wherein the response groups comprise entities or groups of entities.

5. The computer-implemented method of claim 1, wherein the grouping map comprises a plurality of mappings for each response of the plurality of responses.

6. The computer-implemented method of claim 1, wherein the predefined criteria comprises a closest match to a 25%/50%/25% distribution.

7. The computer-implemented method of claim 1, wherein the output comprises at least a cross-tab.

8. The computer-implemented method of claim 1, wherein the plurality of factors comprises at least one of age, ethnicity, gender, income, and/or location.

9. The computer-implemented method of claim 1, wherein the predefined criteria comprise at least one of non-mathematical and/or semantic criteria.

10. The computer-implemented method of claim 1, wherein the selecting of the fractional grouping is based at least in part on a comparison of the fractional groupings to a Gaussian distribution.

11. A system for optimizing clustering outputs, comprising:
a processor; and
a memory comprising instructions stored thereon, which when executed by the processor, causes the processor to perform:
receiving data collected from a plurality of respondents through a survey comprising a plurality of questions, the data comprising a plurality of responses to the plurality of questions by the plurality of respondents;
grouping the plurality of respondents to a plurality of response groups based on a plurality of factors;
calculating, for each question of the plurality of questions, a fractional breakdown of each response group based at least in part on each response to each question;
calculating, for each response group of the plurality of response groups, a plurality of fractional groupings based at least in part on a grouping map;
selecting, for each response group of the plurality of response groups, a fractional grouping from the plurality of fractional groupings that satisfies a predefined criteria; and
causing display of the selected fractional groupings as an output.

12. The system of claim 11, further comprising stored sequences of instructions, which when executed by the processor, cause the processor to perform:
replacing, for each response of the plurality of responses, values of the data with the fractional grouping that was selected.

13. The system of claim 11, wherein the plurality of fractional groupings and a desired distribution are represented as vectors having coordinates in a Cartesian plane, wherein vectors that are within a minimum Euclidean distance from the desired distribution are selected.

14. The system of claim 11, wherein the response groups comprise entities or groups of entities.

15. The system of claim 11, wherein the grouping map comprises a plurality of mappings for each response of the plurality of responses.

16. The system of claim 11, wherein the predefined criteria comprises a closest match to a 25%/50%/25% distribution.

17. The system of claim 11, wherein the output comprises at least a cross-tab.

18. The system of claim 11, wherein the plurality of factors comprises at least one of age, ethnicity, gender, income, and/or location.

19. The system of claim 11, wherein the predefined criteria comprise at least one of non-mathematical and/or semantic criteria.

20. A non-transitory computer-readable storage medium comprising instructions stored thereon, which when executed by one or more processors, cause the one or more processors to perform operations for optimizing clustering outputs, the operations comprising:
receiving data collected from a plurality of respondents through a survey comprising a plurality of questions, the data comprising a plurality of responses to the plurality of questions by the plurality of respondents;
grouping the plurality of respondents to a plurality of response groups based on a plurality of factors;
calculating, for each question of the plurality of questions, a fractional breakdown of each response group based at least in part on each response to each question;
calculating, for each response group of the plurality of response groups, a plurality of fractional groupings based at least in part on a grouping map;
selecting, for each response group of the plurality of response groups, a fractional grouping from the plurality of fractional groupings that satisfies a predefined criteria; and
causing display of the selected fractional groupings as an output.
